(19) United States
(12) Patent Application Publication
(10) Pub. No.: US 2006/0232865 A1
(43) Pub. Date: Oct. 19, 2006

(54) Optical fingerprint prism

(75) Inventor: Yu Min, Hong Kong (HK)

Correspondence Address: AKERMAN SENTERFITT, P.O. BOX 3188, WEST PALM BEACH, FL, 33402-3188, US

(73) Assignee: Adel Group (Asia) Ltd, Hong Kong (HK)

(21) Appl. No.: 11/398,977

(22) Filed: Apr. 6, 2006

(30) Foreign Application Priority Data
Apr. 17, 2005 (CN) 200510034289.X

(51) Int. Cl. G02B 5/04

(52) U.S. Cl. 359/835

(57) ABSTRACT

A kind of optical fingerprint prism is disclosed. It has a solid structure with the surface comprising a ridge face (1), a ridge face (2), a left end face (3), an upper plane (4), a lower plane (5), a front plane (6) and a back plane (7); the ridge face (1) and (2) form right angle; finger is placed on the position of a section GH of the front plane (6), and the CE section of the back plane (7) is coated with extinction paint. The invention utilizes the total reflection principle and the structure of the ridge prism, shortening the light path and decreasing the volume of the system. Compared with the conventional light path, it decreases light loss and increases product accuracy.

### TECHNICAL FIELD

The present invention relates to the field of optical technique, especially to an optical fingerprint identification system for scanning fingerprints.

### TECHNICAL BACKGROUND

Most optical fingerprint collectors in the conventional art have adopted the method of adding the optical elements to reach better scanning effect, resulting in complex structure and large size. With the social development, higher and higher requirements are needed for the products. And some portable, small products have been in the favor more and more and applied in various industries more widely, such as fingerprint door lock, fingerprint entrance guard control system, e-commerce, bank deposit, social insurance, PC, even mobile phones, etc.

### SUMMARY OF INVENTION

The object of the present invention is to provide a latest optical fingerprint prism, which features small size, simple structure, convenient use and low production cost, etc.

For the above object, the technical scheme of the present invention is as follows: An optical fingerprint prism with a physical structure is provided, whose surface comprises a ridge surface 1, a ridge surface 2, a left end surface 3, an upper plane 4, a lower plane 5, a front plane 6 and a rear plane 7. The angel 8 formed between the ridge surfaces 2 and 3 is a right angle. The GH section of the front plane 6 is a location for placing a finger, and the CE section of the rear plane 7 is painted with black dim paint.

According to the present invention, the total reflection principle of the light and the structure of the ridge prism result in short light path and reduction of the system's size. Compared with the conventional light path, the application of the ridge prism reduces more loss of the light and thus improves accuracy of the product.

### DESCRIPTION OF ATTACHED DIAGRAMS

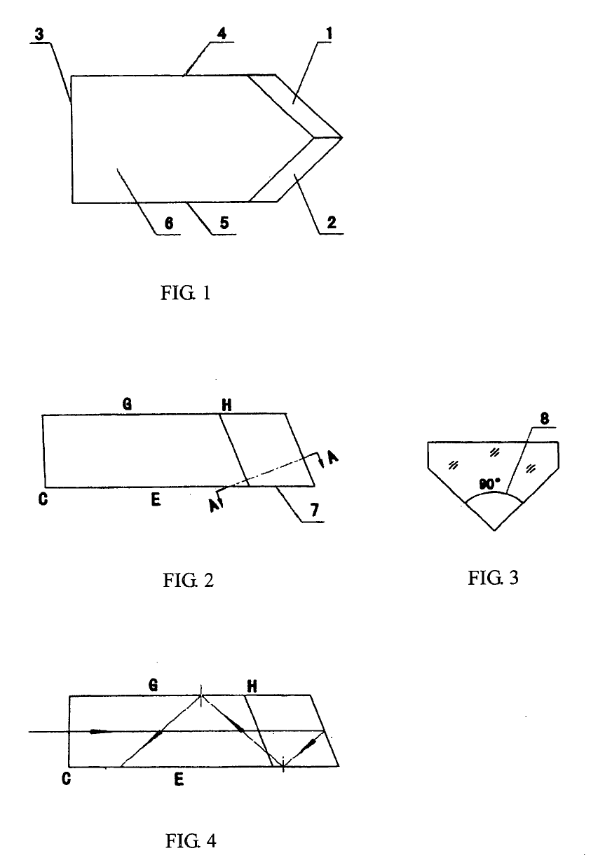

FIG. 1 shows a front view of the present invention;

FIG. 2 shows a bottom view of FIG. 1 of the present invention;

FIG. 3 shows an A-A rotary section view of FIG. 2 of the present invention;

FIG. 4 shows a light path of the present invention.

### DESCRIPTION OF PREFERRED EMBODIMENTS

The present invention is described in detail as follows with reference to attached diagrams and preferred embodiments:

An optical fingerprint prism with a physical structure is provided, whose surface comprises a ridge surface 1, a ridge surface 2, a left end surface 3, an upper plane 4, a lower plane 5, a front plane 6 and a rear plane 7. The angel 8 formed by the ridge surfaces 2 and 3 is a right angle. The GH section of the front plane 6 is a location for placing a finger, and the CE section of the rear plane 7 is painted with black dim paint.

As shown in FIG. 4, the light vertical to the left end surface 3 is received by the prism and then falls onto the ridge surfaces 1 and 2. Both of the ridge surfaces 1 and 2 act jointly, just like a plane viewfinder, so the light can fall onto the rear plane 7. At this point, the condition for total reflection is satisfied, and the light is reflected and then falls onto the GH section of the front plane 6. Similarly, at this point, the condition for total reflection is satisfied and finally, the light reaches the CE section of the rear plane 7, which is painted with black dim paint.

The finger is put on the CE section of the rear plane 6. The fingerprint is referred to lines protruding on the surface of the fingertips, on which the “ridge” will contact the glass to damage conditions for the total reflection, so the incident light on this part will be absorbed by fingers and thus lost. While the “valley” on the lines will not contact the glass and conditions for the total reflection are satisfied, so the light on this part will be reflected onto the CE section of the rear plane 7, which is painted with black dim paint. Clear pictures of the finer lines are available on the left end surface 3 due to the reversible principle of the light path.

What is claimed is:

1. An optical fingerprint prism, characterized in that it is in a physical structure, and its surface comprises a ridge surface (1), a ridge surface (2), a left end surface (3), an upper plane (4), a lower plane (5), a front plane (6) and a rear plane (7); the angel (8) formed between the ridge surfaces (2) and (3) is a right angle; the GH section of the front plane (6) is a location for placing a finger, and the CE section of the rear plane (7) is painted with black dim paint.
